(19) United States
(12) Patent Application Publication
(10) Pub. No.: US 2015/0121471 A1
(43) Pub. Date: Apr. 30, 2015

(54) System and Method for Providing Access to a Proximate Accessory Device for a Mobile Device

(71) Applicant: Nordstrom Inc., Seattle, WA (US)

(72) Inventors: Syam Kunjukrishnan, Seattle, WA (US); Clara Belan, Seattle, WA (US); Rajesh Kanna Rajagopolan Kuppusamy, Seattle, WA (US)

(21) Appl. No.: 14/523,519

(22) Filed: Oct. 24, 2014

Related U.S. Application Data
(60) Provisional application No. 61/895,933, filed on Oct. 25, 2013.

(51) Int. Cl. H04L 29/08; H04L 29/06

(52) U.S. Cl. CPC H04L 67/32; H04L 63/10
USPC 726/4; 709/225

(57) ABSTRACT

Systems and methods are shown for providing access to proximate accessory devices for a mobile client. The mobile client directly physically scans a physical device identifier of a proximate accessory device to obtain a device identifier value. In one approach, a message is transmitted to an accessory access service that includes the scanned device identifier value and a task to be performed by the proximate accessory device and the service sends the task to the proximate accessory device. In another approach, a message that includes the scanned device identifier value is sent to an accessory access service, which obtains a network address corresponding to the scanned device identifier value and returns the network address to the mobile client, and the mobile client sends a task to the proximate accessory identifier value.

### CROSS REFERENCE TO RELATED APPLICATIONS

This application claims priority to U.S. Provisional Patent Application No. 61/895,933, filed Oct. 25, 2013, and entitled “SYSTEM AND METHOD FOR PROVIDING ACCESS TO A PROXIMATE ACCESSORY DEVICE FOR A MOBILE DEVICE”, which is incorporated by reference in its entirety for all purposes.

### BACKGROUND

Users of mobile devices make increasing use of publicly available networks, such as wireless networks in airports and coffee shops, or guest access networks, such as wireless networks in offices or schools.

### SUMMARY

According to one aspect of the present invention, an example of a system for providing access to accessory devices is shown, the system including a network having wireless access and one or more accessory devices, where each device is in communication with the network and has a physical device identifier. The system also includes an accessory access service in communication with the network that is configured to obtain a network address corresponding to the physical device identifier for each of the accessory devices, receive a request that includes a physical device identifier value and a task, and forward a received request to the network address corresponding to a physical device identifier included in the received request.

According to another aspect of the present invention, an example of a method is shown for providing a mobile device with access to accessory devices on a publicly available network. The method includes providing each of one or more accessory devices communicatively coupled to the network with a physical device identifier, directly scanning the physical device identifier of a proximate accessory device using the mobile device, and transmitting a message from the mobile device to an accessory access service for the network, where the message includes the scanned physical device identifier value and a task to be performed by the proximate accessory device. The method also calls for receiving the message from the mobile device in an accessory access service and, in response, obtain a network address corresponding to the received physical device identifier value and forward the received request to the network address corresponding to the received physical device identifier value included in the received request.

### BRIEF DESCRIPTION OF THE DRAWINGS

Various embodiments in accordance with the present disclosure will be described with reference to the drawings, in which:

FIG. 1 is a schematic diagram depicting an example of a system for providing access to a proximate accessory device to a mobile device in accordance with certain aspects of the present invention;

FIG. 2 is a control flow diagram illustrating the steps or stages of an exemplary process that may be performed in a mobile device for obtaining access to a proximate accessory device in accordance with at least one embodiment of the invention;

FIG. 3 is a control flow diagram illustrating the steps or stages of an exemplary process that may be performed in an accessory access server in response to the mobile device process of FIG. 2 in accordance with the one embodiment of the invention;

FIG. 4 is a control flow diagram illustrating the steps or stages of another exemplary process that may be performed in a mobile device for obtaining access to a proximate accessory device in accordance with at least one embodiment of the invention;

FIG. 5 is a control flow diagram illustrating the steps or stages of an exemplary process that may be performed in a mobile device for purchasing an item using a proximate payment terminal device in accordance with at least one other embodiment of the invention;

FIG. 6 is a schematic diagram depicting another example of a system for providing access to a proximate accessory device to a mobile device in accordance with certain aspects of the present invention;

FIG. 7 is a control flow diagram illustrating the steps or stages of another exemplary process that may be performed in a mobile device for transmitting a request to a proximate accessory device in accordance with the example of FIG. 6;

FIG. 8 is a control flow diagram illustrating the steps or stages of an exemplary process that may be performed in an accessory access server in response to the mobile device process of FIG. 7;

FIG. 9 is a control flow diagram illustrating the steps or stages of an exemplary process that may be performed in a mobile device for obtaining access to a wireless network and downloading a remote device access application;

FIG. 10 is a control flow diagram illustrating the steps or stages of an exemplary process that may be performed in an accessory access server in response to the mobile device process of FIG. 9 to authenticate and grant access to a user and download the remote device access application; and

FIG. 11 depicts aspects of elements that may be present in a computer device and/or system configured to implement a method, system and/or process in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

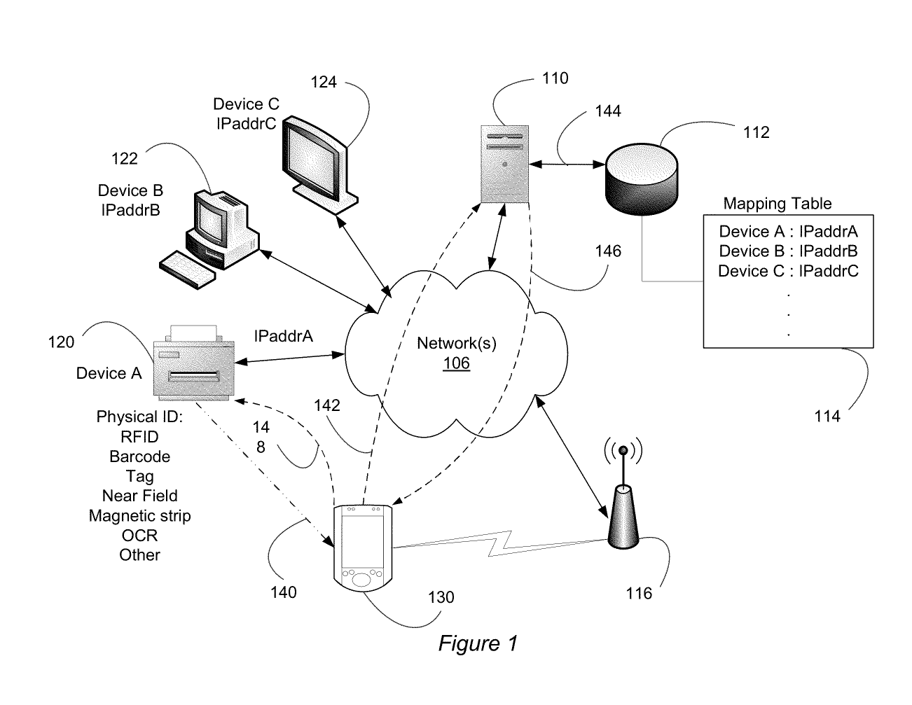

FIG. 1 depicts aspects of an example of a system 100 for providing access to a proximate accessory device, such as printer 120, point of sale terminal 122 or interactive terminal 124, to a mobile device 130 in accordance with certain aspects of the present invention. In this example, the mobile device 130 is in the immediate physical proximity of printer 120, which the user desires to use in combination with the mobile device 130, e.g. to print a document, such as an invoice. The mobile device 130 is used to directly identify the auxiliary device 120 using functionality provided by the mobile device 130 or an attachment that permits the auxiliary device 120 to be identified through direct physical, visual, short-range electromagnetic, or other technologies that can be utilized due to the close physical proximity between the mobile device 130 and the target device that the user wants to use.

For example, a variety of client processes incorporated into a variety of computing devices 120, 122, 124 and 130 may communicate with a distributed computing server or service 110 through one or more networks 106. For example, a client may incorporate and/or be incorporated into a client application (e.g., software) implemented at least in part by one or more of the computing devices. Examples of suitable computing devices include personal computers, server computers, desktop computers, laptop computers, notebook computers, personal digital assistants (PDAs), smart phones, cell phones, and consumer electronic devices incorporating one or more computing device components such as one or more processors, central processing units (CPU), or controllers. Examples of suitable networks 106 include networks utilizing wired and wireless communication technologies and networks operating in accordance with any suitable networking and/or communication protocol (e.g., the Internet).

In this example, mobile client device 130 is wirelessly connected to a network 106 through a wireless access device 116, e.g. a wireless access point or router, that permits communication with a variety of client devices 120, 122 and 124 and an accessory access server or service 110. The mobile device 130 is configured, e.g. through a client application or configuration information downloaded during access authentication of mobile device 130 to network 106, to interact with the accessory access server 110 in accordance with certain aspects of the present invention. The mobile device 130, or the client application on the mobile device, is also configured to obtain a physical identifier for a proximate device using the functionality of the mobile device 130. In one example, the functionality in the mobile device enables a user to directly scan the physical ID of a proximate device. For example, the proximate device may include a radio frequency identifier (RFID), a barcode, a tag, a near field communication device, a magnetic strip, a label for optical character recognition (OCR), or other means for directly identifying the proximate device, e.g. devices 120, 122 and 124, that is physically close to the client device, e.g. mobile device 130. In another example, a user of the mobile device 130 may enter an identifier value printed on a tag or label attached to the proximate device.

In the example of FIG. 1, a user holding mobile device 130 is standing next to printer 120, which the user wants to use to print a document. Printer 120 has a physical identifier attached to it that can be scanned using mobile device 130 to obtain the devices physical ID, e.g. “Device A”. Mobile device 130 first scans 140 and then transmits 142 the scanned device ID value “Device A” to accessory access server 110 or a similar service. Accessory access server 110 accesses 144 a mapping table 114 in storage device 112 or other suitable approaches that map or transform physical device ID values to network addresses, e.g. Device A maps to IPaddrA. In this embodiment, accessory access server 110 returns the network address value 146 to mobile device 130. Mobile device 130 then uses the network value IPaddrA to send its request 148 through network 106 to printer 120. In this way, a mobile user can easily access an accessory device that is in the user's physical proximity by walking up to the accessory device, scanning the device, using the scanned device ID to obtain the network address for the accessory device, and exchanging data or commands with the accessory device via the network.

Note that the example computing environment depicted in FIG. 1 is not intended to be a limiting example. Alternatively, or in addition, computing environments in accordance with at least one embodiment of the invention may include any suitable system that permits mobile users to gain access to the system. Examples of suitable systems include wireless networks for offices, stores, coffee shops, libraries, business centers, and airports. Although further examples below may reference the example computing environment depicted in FIG. 1, it will be apparent to one of skill in the art that the examples may be adapted for alternate computing devices, systems, and environments.

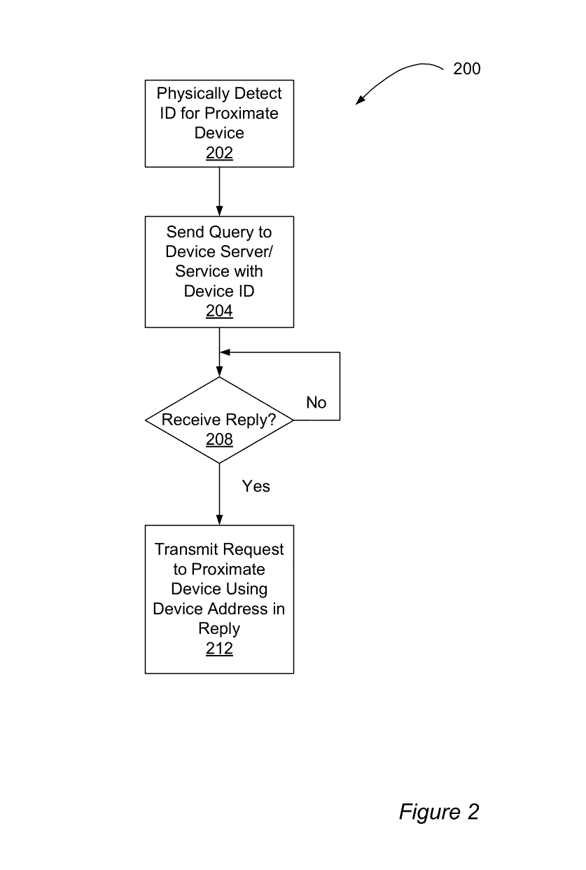

FIG. 2 is a control flow diagram illustrating the steps or stages of an exemplary process 200 that may be performed in a mobile device, such as mobile device 130 in FIG. 1, for obtaining access to a proximate accessory device, such as printer 120, in accordance with at least one embodiment of the invention. For purposes of this example, the process will be described in the context of the computing environment shown in FIG. 1, though it may be applied in different contexts than the one shown. The process 200 may be performed by an application program installed on a mobile device. For example, the application program could be downloaded to the mobile device as part of an authentication process for granting the mobile device access to a wireless network. Other examples include an application previously loaded onto the mobile device or a browser application, such as a website interface utilized for network authentication.

At step 202, the mobile device is used to physically detect an identifier (ID) for a proximate device by, for example, scanning a physical identifier attached or associated with the proximate device. The physical ID may be scanned using functionality provided in the mobile device, such as optical tag reading or optical character recognition using a camera installed on the mobile device, or that can be obtained from a module attached to the mobile device, such as a magnetic strip reader or barcode reader. At step 204, the mobile device sends a query to an accessory device server or service, such as accessory device server 110, and, at step 208, waits for a reply from the accessory server that contains the network address, e.g. IPaddrA, that corresponds to the physical ID, e.g. DeviceA. When a reply is received, the mobile device, or an application on the mobile device, transmits a request at step 212 using the device network address received in the reply to send a task to the proximate device using the network that both the mobile device and proximate device are connected, e.g. network 106.

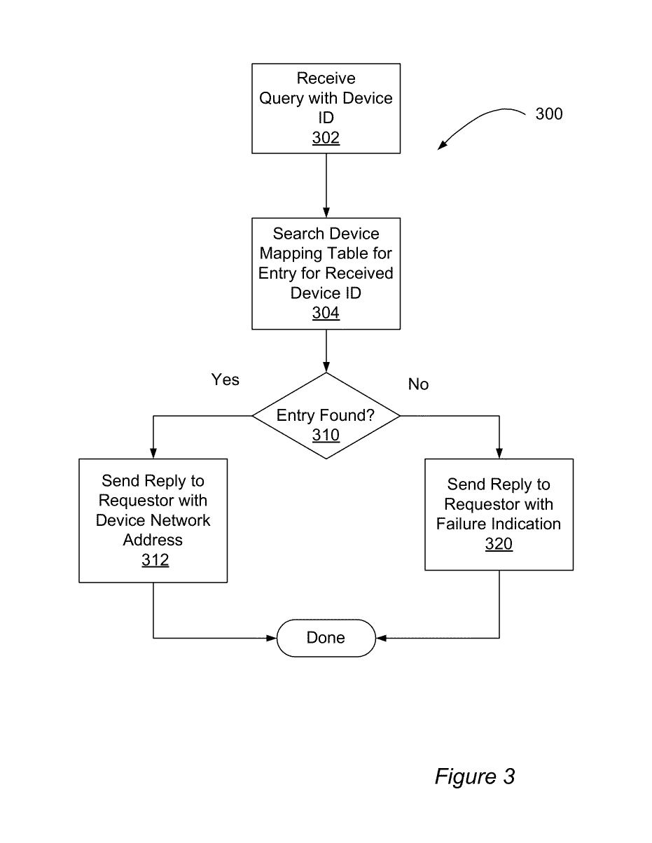

FIG. 3 is a control flow diagram illustrating the steps or stages of an exemplary process 300 that may be performed in an accessory access server, such as server 110 in FIG. 1, in response to the mobile device process of FIG. 2 in accordance with one embodiment of the invention. At step 302, a query is received that contains a physical device ID, which is used, at step 304, to search a device mapping table for an entry corresponding to the physical device ID received at step 302. If an entry is found, then control flow branches at step 310 to step 312, where the server sends a reply to the requestor that contains the device network address, e.g. IPaddrA, from the found entry. If no entry is found, then, in this example, control flow branches at step 310 to step 320, where a reply indicating a failure is sent to the requestor. Note that the accessory access server or service may be combined with a network access server that is used to authenticate a mobile device for use on the network utilized by the accessory devices and the mobile user.

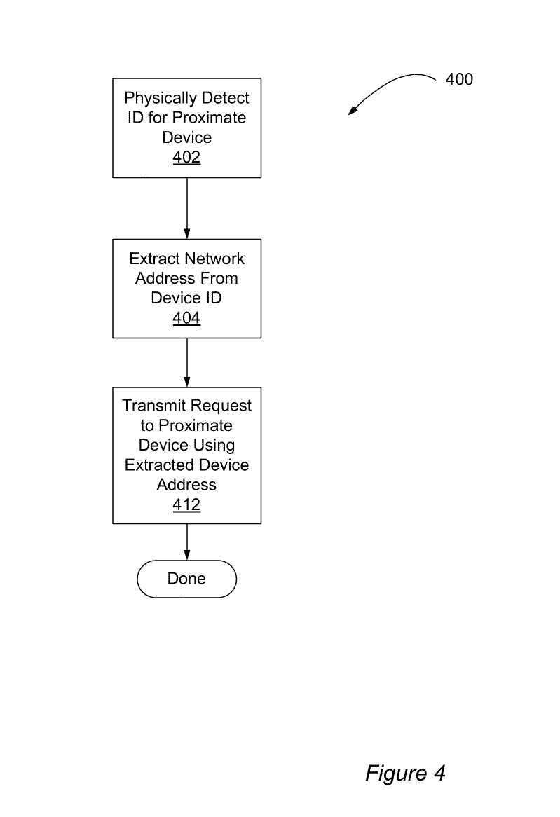

FIG. 4 is a control flow diagram illustrating the steps or stages of another exemplary process 400 that may be performed in a mobile device for obtaining access to a proximate accessory device in accordance with at least one embodiment of the invention. In the context of this example, the physical device IDs are configured so that the device network address can be extracted from the physical device ID. In one approach consistent with this example, an application program in mobile device 130 is configured to scan the physical device ID at step 402 and extract the device network address from the scanned physical device ID at step 404. For example, the physical device ID, e.g. bar code, tag, or label, has the network address embedded or incorporated in it in a format recognizable to the application program, e.g. “10.01.244.1” encoded optically or magnetically. The extracted network address is then used by the mobile device to transmit a request, at step 412, to the accessory device, e.g. printer 120, through the network, e.g. network 106. Note that, in this embodiment, no accessory access server is utilized. One approach to controlling access in a network is to only download the application program configured to extract the network address from the physical ID. Alternatively, a device mapping table might be downloaded to the application program on the mobile device at, for example, network access authorization.

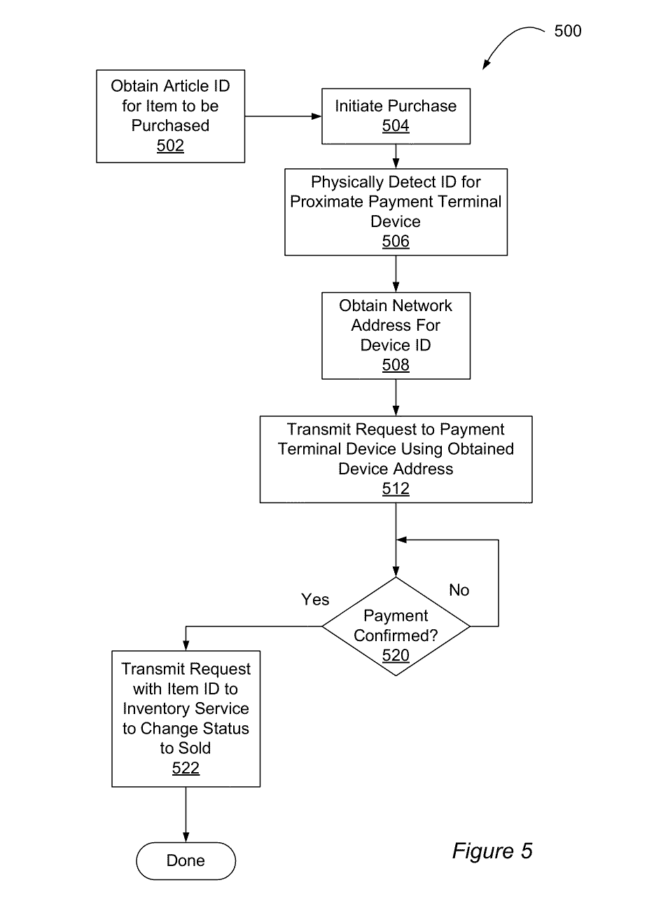

Embodiments of the present invention may be used for a variety of functions in addition to the print scenario described above. FIG. 5 is a control flow diagram illustrating the steps or stages of an exemplary process 500 that may be performed in a mobile device, such as device 130 in FIG. 1, for purchasing an item using a proximate payment terminal device in accordance with at least one other embodiment of the invention.

In this example, at step 502, a user uses an application program on a mobile device, such as mobile device 130 in FIG. 1, to obtain an article identifier, e.g. UPC code, by scanning or a user enters the article identifier. The user initiates purchase of the article at step 504 and scans a proximate payment terminal device to obtain a physical ID, e.g. “Device B”, for the payment terminal device, such as cash register 122 in FIG. 1. Examples of payment terminal devices include self-serve check-out kiosks, ATMs, or cash registers. At step 508, the application in the mobile device obtains a network address for the payment terminal device, e.g. IPaddrB, from an accessory access server or extracting the network address from the physical ID as discussed above with respect to FIGS. 2, 3 and 4, for example.

The mobile device then transmits a request to the payment terminal device using the network address obtained in step 508. This request could be a request to make electronic payment by credit card or account, for example, or the payment terminal device could have a card reader for swiping a credit or debit card, or the payment terminal device could have cash reading capability such that it can identify and credit cash submitted by the user. At step 520, the mobile device, in this example, receives confirmation of the payment. In some embodiments, the payment confirmation may cause the payment terminal device to transmit a request with the item ID for the purchased article to an inventory server or service to change the status of the item to sold and update inventory accordingly. If the article includes an identification device that can be scanned as the article is removed from the premises, e.g. a scan of an RFID tag on the article as the purchaser walks out a doorway, then the status of the article can be indicated as sold so that an alarm is not sounded. Thus, in an example in accordance with one embodiment of the present invention, a mobile device may be utilized to access a payment terminal in the proximity of the mobile device to complete a transaction.

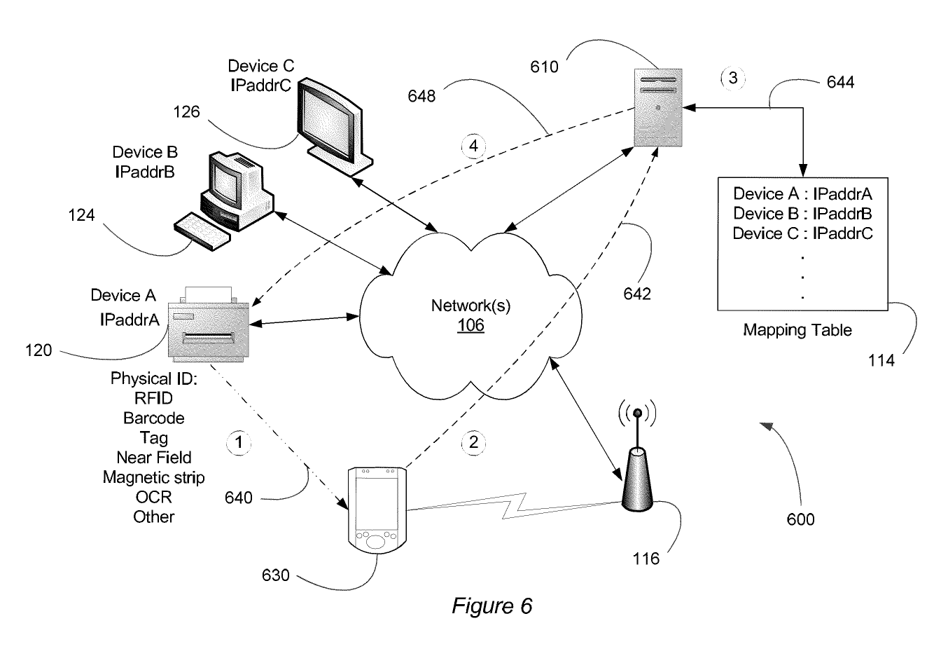

FIG. 6 is a schematic diagram depicting another example of a system 600 for providing access to a proximate accessory device 120 from a mobile device 630 in accordance with certain aspects of the present invention. In the example of FIG. 6, and similar to the example of FIG. 1, a user holding mobile device 630 is standing next to printer 120, which the user wants to use to print a document. As in FIG. 1, printer 120 has a physical identifier attached to it that can be scanned using mobile device 130 to obtain the devices physical ID, e.g. “Device A”. Mobile device 630 first scans 640 the physical identifier attached to the proximate accessory device to obtain the scanned device ID value “Device A”. Mobile device 630 then transmits a request 642 to accessory access server 610 or a similar service that identifies a task to be performed by the proximate accessory device, e.g. printer 120, and include the scanned device ID value for the proximate accessory device. Accessory access server 610 accesses 644 the mapping table 114 that maps physical ID values to network addresses, e.g. Device A maps to IPaddrA. In this embodiment, accessory access server 610 forwards 648 the task to the network address, e.g. IPaddrA, for the proximate accessory device, e.g. printer 120. In this approach, a mobile user can easily access an accessory device that is in the user's physical proximity by walking up to the accessory device, scanning the device, and using the scanned device ID to route a task to the accessory device through the accessory access server or service.

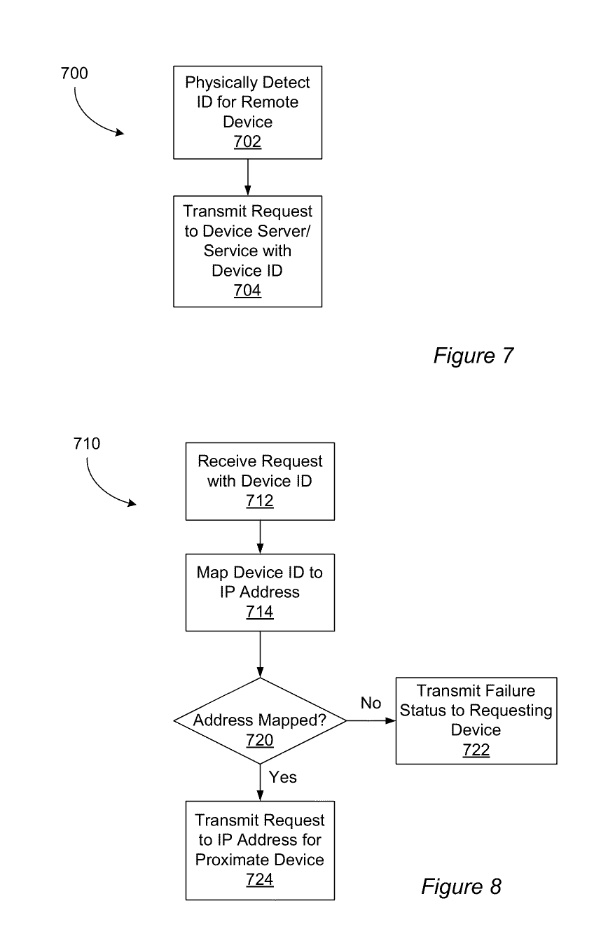

FIG. 7 is a control flow diagram illustrating the steps or stages of another exemplary process 700 that may be performed in a mobile device, such as mobile device 630, for transmitting a request to a proximate accessory device, such as printer 120, in accordance with the example of FIG. 6. Though the process is described in the context of the computing environment shown in FIG. 6, it may be applied in different contexts than the one shown. The process 700 may be performed by an application program installed on the mobile device 630. For example, the application program could be downloaded to the mobile device 630 as part of an authentication process for granting the mobile device access to a wireless network 106. Other examples include an application previously loaded on the mobile device or a browser application, such as a website interface utilized for network authentication. At step 702, the mobile device 630 is used to physically detect an identifier (ID) for a proximate device by scanning a physical identifier attached or associated with the proximate device. As described above, the physical ID may be scanned using functionality provided in the mobile device or that can be obtained from a module attached to the mobile device. At step 704, the mobile device 630 transmits a request to an accessory device server or service, e.g. accessory device server 610, which identifies the desired task and contains the scanned physical ID value, e.g. DeviceA, for the proximate accessory device. Processing of the transmitted request then proceeds to process 710 illustrated in FIG. 8.

FIG. 8 is a control flow diagram illustrating the steps or stages of an exemplary process 710 that may be performed in an accessory access server, such as server 610 in FIG. 6, in response to the mobile device process of FIG. 7 in accordance with one embodiment of the invention. At step 712, the request is received that contains a physical device ID, which is used, at step 714, to search a device mapping table, e.g. 114, for an entry corresponding to the physical device ID received at step 712. If an entry is found, then control flow branches at step 720 to step 724, where the server 610 forwards the request to the device network address, e.g. IPaddrA, from the found entry. If no entry is found, then, in this example, control flow branches at step 720 to step 722, where a reply indicating a failure may be sent to the requestor. Note that the accessory access server or service may be combined with a network access server that is used to authenticate a mobile device for use on the network utilized by the accessory devices and the mobile user.

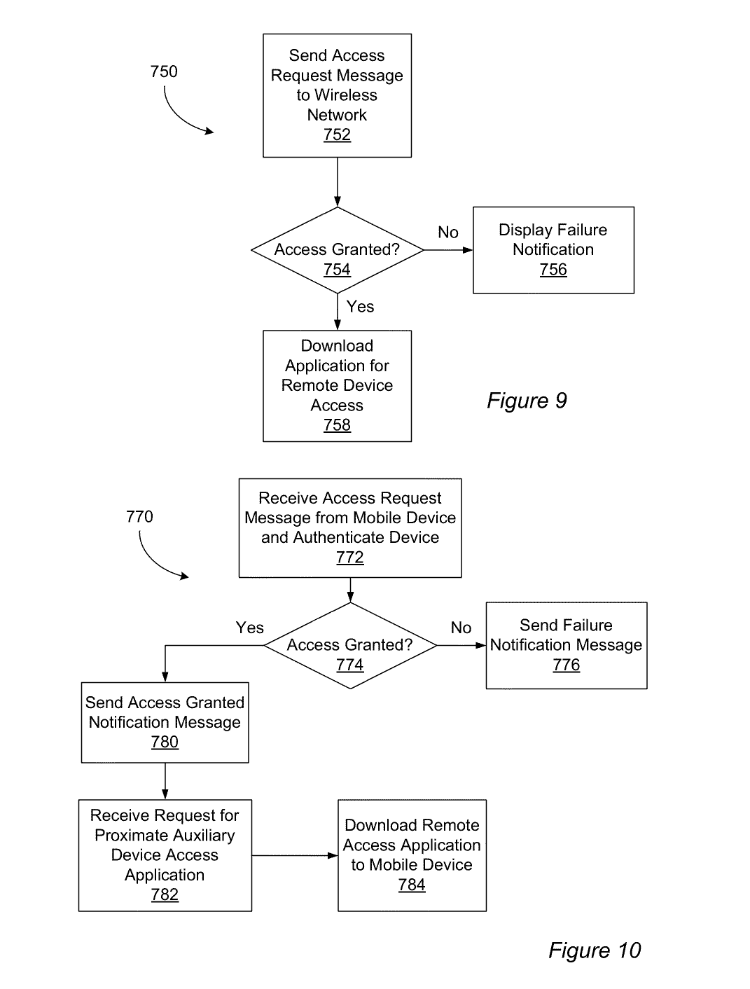

As discussed above with respect to examples of processes for remote device access, an application program may be provided to a mobile device, e.g. mobile device 630 in FIG. 6, as part of an authentication process for granting the mobile device access to a wireless network 106. FIG. 9 is a control flow diagram that illustrates an example of a process 750 in a mobile device for obtaining access to a network and downloading an application for accessing one or more proximate auxiliary devices, as discussed above. At step 752, a user of a mobile device causes the device to send an access request message to obtain wireless access to a network, e.g. network 106 of FIGS. 1 and 6. The access request message may be routed to an authentication service for the network, which, for example, is a service hosted by server 110 of FIG. 1 or server 610 of FIG. 6. At step 754, the mobile device waits for a message indicating whether access to the network has been granted or not. If access is not granted, in this example, control branches to step 756 where a failure notification is displayed to the user of the mobile device. If access is granted, control branches to step 758 where the mobile device downloads a proximate auxiliary device access application by, for example, sending a download request to the authentication server.

FIG. 10 is a control flow diagram that illustrates an example of a process 770 in an authentication server, such as server 110 of FIG. 1 or server 610 of FIG. 6, that interacts with the process 750 in a mobile device to grant the device access to a network and provide a proximate auxiliary device access application. At step 772, the authentication server or service receives the access request message from the mobile device and performs an authentication process for the device, e.g. verifying a password, account information or acceptance of terms of use. If he authentication server or service denies access to the device, then control flows to step 776 where a failure notification message is sent to the mobile device. If access is granted, control branches at step 774 to step 780, where an access granted notification message is sent to the mobile device. At step 782, the authentication server or service receives the request from the mobile device to download the proximate auxiliary device access application, which is downloaded to the mobile device at step 784. Note that alternative approaches may be taken that utilize a web browser for authentication and download of the proximate auxiliary device access application or act as the proximate auxiliary device access application.

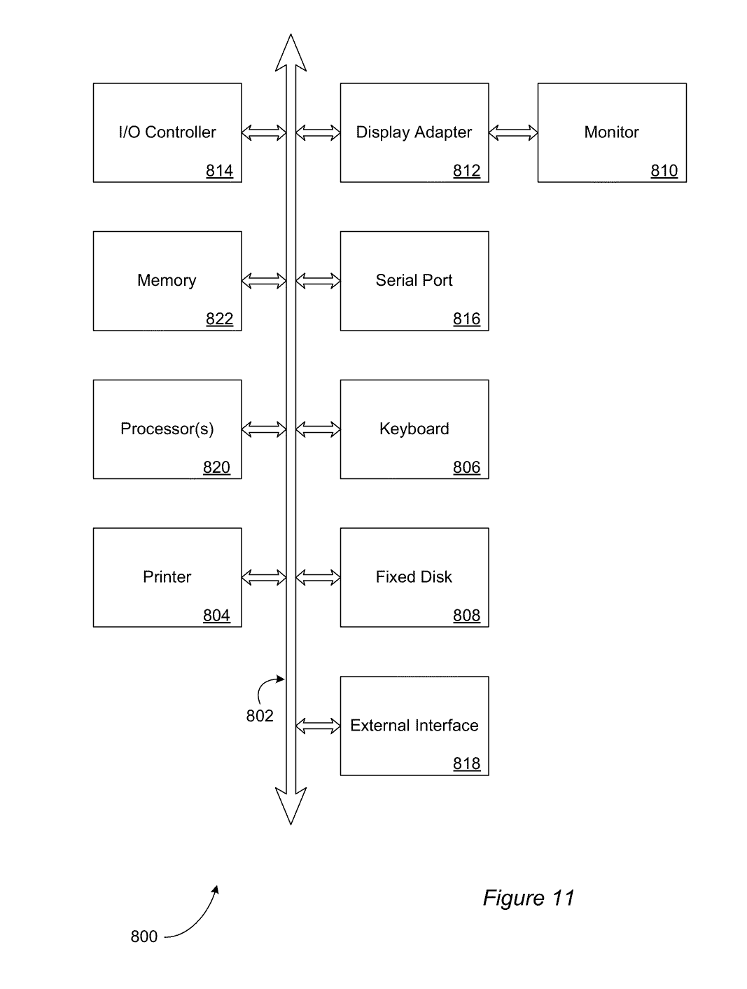

FIG. 11 depicts aspects of elements that may be present in a computer device and/or system configured to implement a method, system and/or process in accordance with some embodiments of the present invention.

In accordance with at least one embodiment of the invention, the system, apparatus, methods, processes and/or operations for providing access to a proximate device from a mobile device may be wholly or partially implemented in the form of a set of instructions executed by one or more programmed computer processors, such as a central processing unit (CPU) or microprocessor. Such processors may be incorporated in an apparatus, server, client or other computing device operated by, or in communication with, other components of the system.

As an example, FIG. 11 depicts aspects of elements that may be present in a computer device and/or system 800 configured to implement a method and/or process in accordance with some embodiments of the present invention. The subsystems shown in FIG. 11 are interconnected via a system bus 802. Additional subsystems include a printer 804, a keyboard 806, a fixed disk 808, and a monitor 810, which is coupled to a display adapter 812. Peripherals and input/output (I/O) devices, which couple to an I/O controller 814, can be connected to the computer system by any number of means known in the art, such as a serial port 816. For example, the serial port 816 or an external interface 818 can be utilized to connect the computer device 800 to further devices and/or systems not shown in FIG. 11 including a wide area network such as the Internet, a mouse input device, and/or a scanner. The interconnection via the system bus 802 allows one or more processors 820 to communicate with each subsystem and to control the execution of instructions that may be stored in a system memory 822 and/or the fixed disk 808, as well as the exchange of information between subsystems. The system memory 822 and/or the fixed disk 808 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl or using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the invention.

We claim:

1. A system for providing access to accessory devices, the system comprising:
a network having wireless access;
one or more accessory devices, each device being communicatively coupled to the network and having a physical device identifier; and
an accessory access service communicatively coupled to the network, the service being configured to:
obtain a network address corresponding to the physical device identifier for each of the accessory devices;
receive a request that includes a physical device identifier value and a task; and
forward a received request to the network address corresponding to a physical device identifier included in the received request.

2. The system of claim 1, the system further comprising:
a mobile client configured to be wirelessly communicatively coupled to the network, the client further configured to:
directly physically scan the physical device identifier of a proximate accessory device to obtain a device identifier value, and
transmit a message to the accessory access service, where the message includes the scanned device identifier value and a task to be performed by the proximate accessory device.

3. The system of claim 2, wherein:
the accessory access service is integrated with a network access authorization service; and
the mobile client is configured to transmit a message to the accessory access service when the mobile client is authorized to access the network.

4. The system of claim 2, wherein:
the accessory access service is integrated with a network access authorization service; and
the mobile client is configured to transmit a message to the accessory access service by downloading a client application to a mobile device for the mobile client when the mobile client is authorized to access the network.

5. The system of claim 2, wherein the task to be performed by the proximate device further comprises at least one of a print task, a scan task, and a payment task.

6. A system for providing access to accessory devices, the system comprising:
a network;
one or more accessory devices, each device being communicatively coupled to the network and having a physical device identifier; and
an accessory access service communicatively coupled to the network, the service being configured to:
receive a request that includes a physical device identifier value;
obtain a network address corresponding to the received physical device identifier value; and
transmit a reply to the request that includes the network address corresponding to the received physical device identifier value.

7. The system of claim 6, the system further comprising:
a mobile client configured to be communicatively coupled to the network, the client further configured to:
directly physically scan the physical device identifier of a proximate accessory device to obtain a device identifier value,
transmit a request to the accessory access service, where the message includes the scanned device identifier value,
receive a reply from the accessory access service that includes a network address that corresponds to the scanned device identifier value, and
transmit a message using the received network address that includes a task to be performed by the proximate accessory device.

8. The system of claim 7, wherein the task to be performed by the proximate device further comprises at least one of a print task, a scan task, and a payment task.

9. A mobile client configured to connect to a network that includes accessory devices each having physical device identifiers, the mobile client being further configured to:
directly physically scan the physical device identifier of a proximate accessory device to obtain a device identifier value; and
transmit a message to a predetermined accessory access service, where the message includes the scanned device identifier value and a task to be performed by the proximate accessory device.

10. The mobile client of claim 9, where the mobile client further comprises an application instantiated on a mobile device.

11. The mobile client of claim 10, where the application instantiated on the mobile device is downloaded to the mobile device when the mobile device is authorized for access to the network.

12. The system of claim 9, wherein the task to be performed by the proximate device further comprises at least one of a print task, a scan task, and a payment task.

13. A mobile client configured to connect to a network that includes accessory devices each having physical device identifiers, the mobile client being further configured to:
directly physically scan the physical device identifier of a proximate accessory device to obtain a device identifier value;
transmit a message that includes the scanned device identifier value to a predetermined accessory access service requesting a network address corresponding to the device identifier value;
receiving a message that includes the network address corresponding to the device identifier value; and
sending a task to the proximate accessory device using the network address corresponding to the device identifier value.

14. The mobile client of claim 13, wherein the task sent to the proximate accessory device further comprises at least one of a print task, a scan task, and a payment task.

15. A mobile client configured to connect to a network that includes accessory devices each having physical device identifiers, the mobile client being further configured to:
directly physically scan the physical device identifier of a proximate accessory device to obtain a device identifier value;
extract a network address corresponding to the proximate accessory device from the scanned device identifier value; and
send a task to the proximate accessory device using the network address extracted from the device identifier value.

16. The mobile client of claim 15, the mobile client being further configured to:
receive and store a table mapping each physical device identifier to a corresponding network address; and
extract the network address corresponding to the proximate accessory device from the scanned device identifier value by mapping the scanned device identifier value to the corresponding network address in the mapping table.

17. The mobile client of claim 15, the mobile client being further configured to extract the network address corresponding to the proximate accessory device from the scanned device identifier value according to a predetermined relationship between device identifier values and network address values.

18. The mobile client of claim 15, wherein the task sent to the proximate accessory device further comprises at least one of a print task, a scan task, and a payment task.

19. A method for providing a mobile device with access to accessory devices on a publicly available network, the method comprising the steps:
providing each of one or more accessory devices communicatively coupled to the network with a physical device identifier;
directly scanning the physical device identifier of a proximate accessory device using the mobile device;
transmitting a message from the mobile device to an accessory access service for the network, where the message includes the scanned physical device identifier value and a task to be performed by the proximate accessory device;
receiving the message from the mobile device in an accessory access service and, responsive thereto perform the following:
obtain a network address corresponding to the received physical device identifier value, and
forward the received request to the network address corresponding to the received physical device identifier value included in the received request.

20. The method of claim 19, the method further comprising the step of configuring the mobile client to transmit messages to the accessory access service when the mobile client is authorized to access the network.

21. The method of claim 20, wherein the step of configuring the mobile client to transmit messages to the accessory access service further comprises downloading a client application to a mobile device when the mobile client is authorized to access the network, where the client application is configured to transmit messages to the accessory access service.
